(19) United States
(12) Patent Application Publication
(10) Pub. No.: US 2004/0095560 A1
(43) Pub. Date: May 20, 2004

(54) Correction optics for flat-panel displays

(76) Inventors: Adrian Robert Leigh Travis, Wrangaton (GB); John Richard Moore, Barton (GB)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 10/470,173

(22) PCT Filed: Jan. 23, 2002
(86) PCT No.: PCT/GB02/00265

(30) Foreign Application Priority Data
Jan. 23, 2001 (GB) 0101682.3

(51) Int. Cl. G03B 21/14

(52) U.S. Cl. 353/79

(57) ABSTRACT

A flat-panel projection display comprises a tapered transparent slab (1), a projector (2) adapted to inject images into the thick end of the slab, a translucent screen (3) over the face of the slab from which the display is to be viewed, and spacers holding the screen away from the slab so that light emerging from the face of the slab can spread to cover the area of the screen. In this way the gaps or blank strips that would otherwise be present at the points where the light bundles are being reflected off the rear surface of the tapered waveguide are eliminated.

This invention is concerned with a way of correcting image distortion in a flat-panel display in which the image is projected from a microdisplay into a tapered transparent slab.

Flat-panel displays which have screens large enough to stimulate the quick reactions of our peripheral vision will give pictures great immediacy, yet because they are flat the displays will fit easily onto the wall of a room. The size of conventional flat-panel displays however is limited by the resistance-capacitance product of the row and column transparent conductors, and by the area over which lithography can be sufficiently precise to make transistors. The cost of making active-matrix liquid-crystal displays with screen diagonals greater than one meter is prohibitive, and even the cheaper plasma displays are too expensive for most uses. However, the 2″ by 21″ liquid-crystal displays used in video projectors are relatively cheap, while fingernail-sized microdisplays look set to cost only a few dollars.

Video projectors comprise a two-dimensional display, a projection lens and a translucent screen, and the projection lens forms on the translucent screen a magnified image of the two-dimensional display which can be almost as big as one wants. Video projectors are cheap so are becoming increasingly popular, but if the projector is pointed at the front of the translucent screen then often the projector gets in the way of the viewer, or the viewer gets in the way of the projected light. Furthermore unless the room lights are dimmed, the image looks washed out because the screen scatters background light as well as the projected image. The projector can instead be pointed at the rear of the screen so that there is nothing between the viewer and the screen, and the screen made to scatter only light incident on its rear, but rear-projection displays are bulky.

Recently there was disclosed in the applicant's WO 01/72037 a tapered display which comprises a video projector and a slim wedge of glass or transparent plastic. The video projector itself comprises of a source of approximately collimated illumination, a microdisplay, a condensing lens and a projection lens. As the rays leave the projection lens they form a narrow waist. At this point the rays are passed into the thick end of the wedge. When a ray is shone into the thick end of a slim wedge, then the out-of-plane angle measured with respect to one face of the wedge will change each time the ray reflects of the opposite face of the wedge. Eventually the ray propagates far enough along the wedge that the out-of-plane angle becomes greater than the critical angle, and at this point light escapes the wedge. The distance into the wedge at which the ray leaves the wedge is therefore determined by the angle at which the ray is injected. In this way the 2D array of pixels on the microdisplay is mapped one-to-one to a 2D array of pixels on the face of the wedge. An anti-reflection coating is desirable to ensure that all the light leaves the screen when the ray reaches the critical angle, since otherwise there is blurring between adjacent rows of the image.

The tapered display shares many of the advantages of a rear-screen projection display, but the projected image gets separated into horizontal bands separated by dark gaps or bands because there is no light emerging at the points where the light changes from n internal reflections to n+1 reflections.

According to one aspect of the present invention there is provided a flat-panel projection apparatus, in particular a display, comprising a tapered transparent slab, a projector adapted to inject images into, or a light-sensitive device receiving images from, the thick end of the slab, a translucent screen over the face of the slab from which the display is to be viewed, and means for holding the screen at a predetermined spacing from the slab so that light emerging from the face of the slab can spread to cover the area of the screen.

This spacing or gap should generally be proportional in height to the thickness of the tapered waveguide at that point. The gap need not be air: it could be filled with a solid or gel of the right optical qualities. This could act as a spacer to support the screen, particularly for larger displays. Otherwise the holding means could be a set of spacers around the edge of the screen, or over the area of the screen.

In another aspect the invention provides a flat-panel projection apparatus including a flat input slab waveguide, and a tapered output slab waveguide arranged to receive light from the input waveguide after having been expanded in its plane, in which the transition from the input waveguide to the tapered waveguide is gradual.

According to a third aspect there is provided a projector comprising a light source, a tapered slab waveguide into the thick end of which the light is injected so as to emerge over the face of the waveguide, and a display element modulating this light and reflecting it back through the waveguide.

For a better understanding of the invention, embodiments will now be described by way of example with reference to the accompanying drawings, in which:

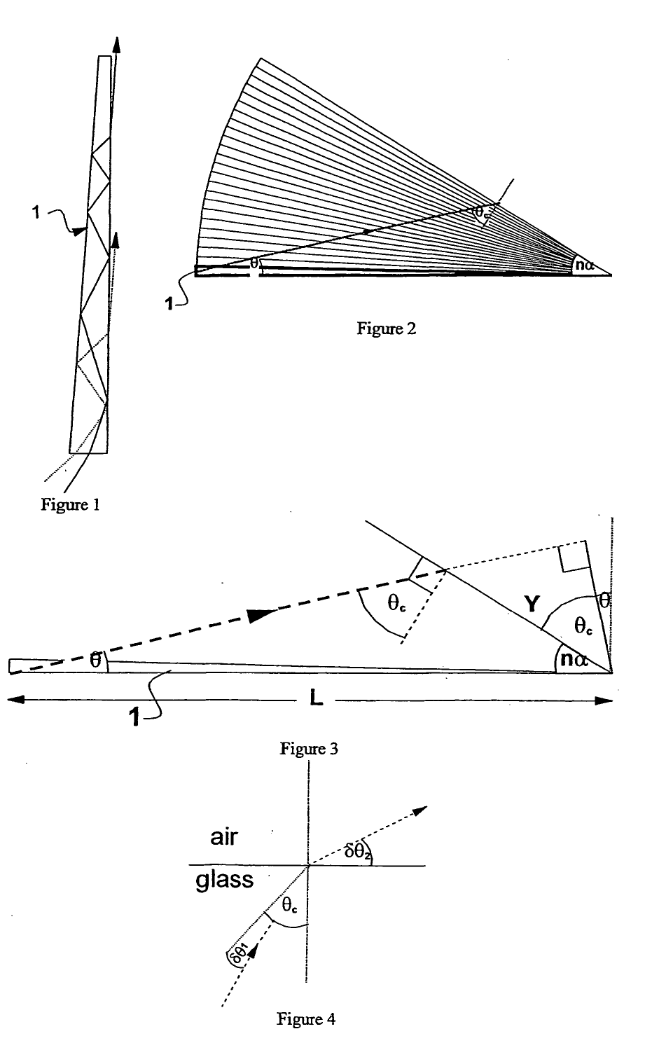

FIGS. 1 to 4 illustrate the basic options of the tapered waveguide system;

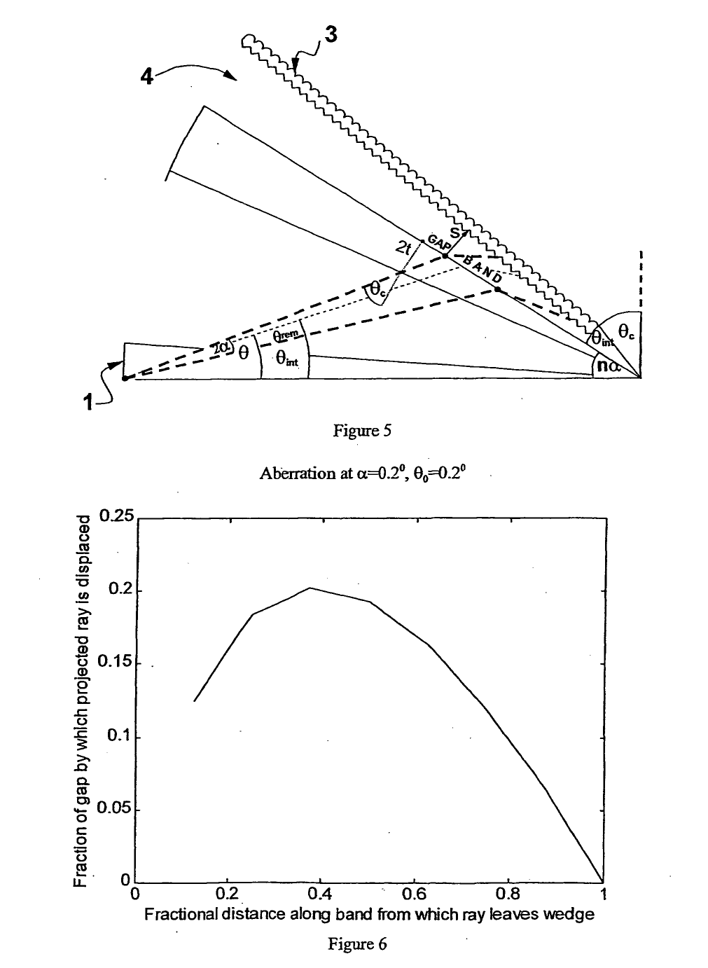

FIG. 5 shows the principle behind the invention;

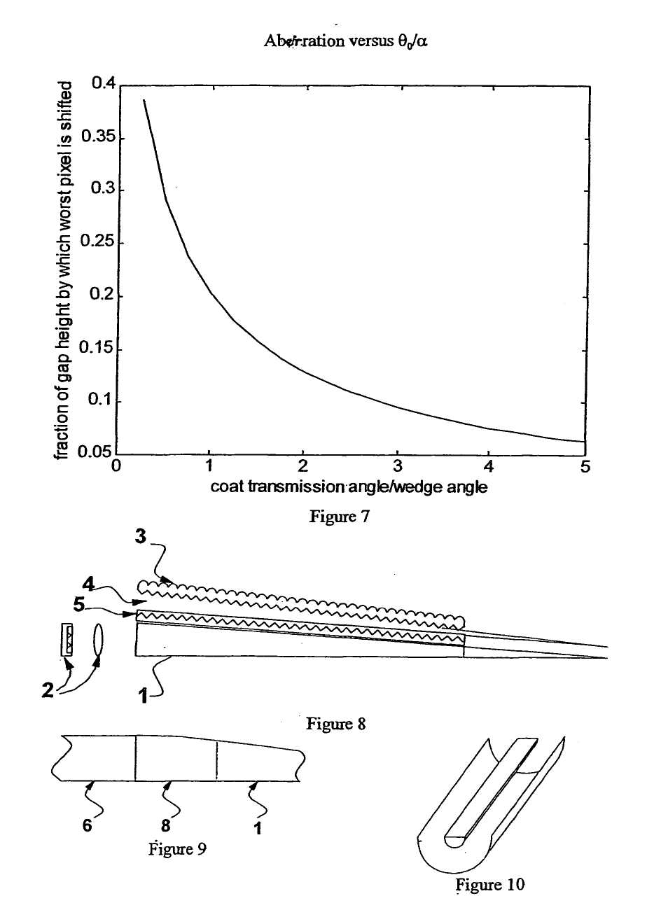

FIGS. 6 and 7 are graphs showing the effects of projection across the spacing between waveguide and screen;

FIG. 8 shows a second embodiment in which a prismatic film is inserted between the tapered transparent slab and the translucent screen in order to eliminate gaps without distortion;

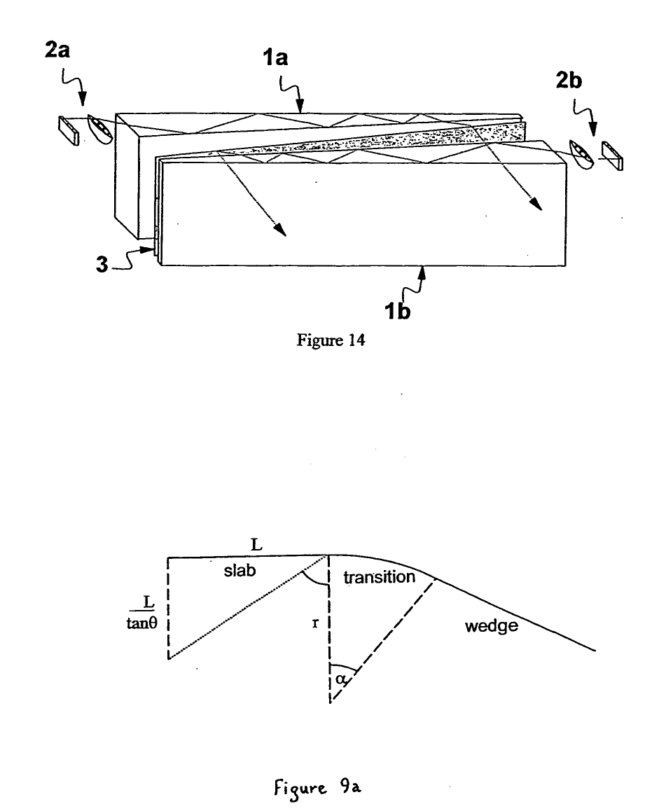

FIGS. 9 and 9a show a third embodiment in which the rate of change of thickness into the tapered slab is varied from zero to the desired taper angle without causing aberrations in the final image by making the transition gradual;

FIG. 10 illustrates a cylindrical Dyson lens which can be used to fold the system;

FIG. 11 illustrates a graded-index curve which can be used to fold the system;

FIG. 12 shows how the image from the video projector can be both magnified and compactly folded within the system;

FIG. 13 shows how a wedge, space, holographic optical element and liquid-crystal display can be used as a compact video projector; and

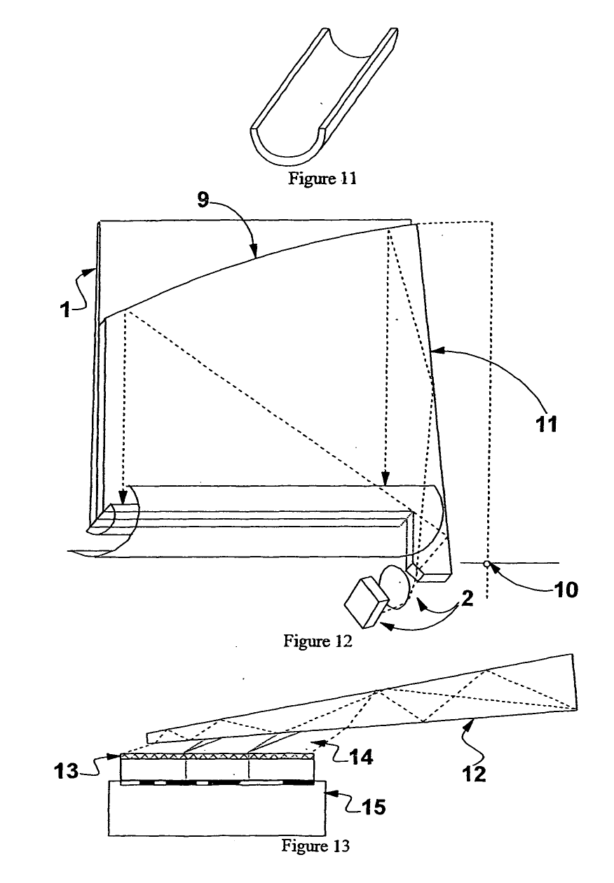

FIG. 14 shows how two wedges placed base to tip can be used to give flat-panel projection without folding.

FIGS. 1 to 3 show the principle of operation of the wedge-shaped waveguide display, as explained in WO 01/72037. FIG. 1 illustrates how the distance which a ray of light propagates along a tapered transparent slab is determined by the angle at which the ray is injected. FIG. 2 illustrates how the passage of a ray through the tapered slab can be found by tracing a straight ray through mirror images of the tapered slab. FIG. 3 illustrates the trigonometry of FIG. 2 for an average ray. FIG. 4 shows how when a ray is incident on a glass/air interface at close to the critical angle, the angle of emergence is approximately the square root of twice the angle of incidence, as can be easily shown using Snell's Law.

FIG. 5 shows the principle behind the present invention, by analogy with FIG. 3. A screen 3 is placed over the slab with a gap 4, with a tapered gap between it and the slab. FIG. 5 shows schematically how rays traced through mirror images of the tapered slab so as to form at the last surface a horizontal band, can be expanded to fill the adjacent gap by creating a space between the tapered transparent slab and the translucent screen (The physical setup is similar to that shown in FIG. 8 discussed below).

The tapered transparent slab 1 is configured as a wedge with an anti-reflection coating on one surface, and into its thick end is pointed a video projector 2. The gaps between the bands into which the projected image is divided are eliminated by placing a translucent screen 3 adjacent to the coated surface of the tapered transparent slab, and providing a space 4 between slab and screen so that the planes formed by the bottom of the screen and the two surfaces of the wedge will, if all extended, meet at a common line. The angle a between the translucent screen and adjacent wedge surface should be:

$$σ = α \frac{2 \sqrt{2} {( {n}^{2} - 1 )}^{- 1 / 4}}{\frac{1}{\sqrt{{θ}_{0}}} - \frac{1}{\sqrt{{θ}_{0} + 2 α}}}$$

where n is the refractive index of the wedge, a is the angle of taper of the wedge, and θ₀ is the angle by which a ray's incident angle must be less than the critical angle if it is to be substantially (say 50%) transmitted by the glass/air interface next to the translucent screen.

For tapered transparent slabs whose taper profile is different from that of a wedge but varies smoothly, the translucent screen should be shaped so that the thickness of the space 5 between screen and slab surface at any point is proportional to the thickness t of the wedge next to that point. The constant of proportionality is given by:

$$s \approx 2 t \frac{1}{\sqrt{{n}^{2} - 1}} {( \frac{1}{\sqrt{2 {θ}_{0} \sqrt{{n}^{2} - 1}}} - \frac{1}{\sqrt{2 ( {θ}_{0} + α ) \sqrt{{n}^{2} - 1}}} )}^{- 1}$$

For other shapes of transparent slab, the shape and distance of the translucent screen from the slab can be calculated in the same way as for a wedge-shaped slab, which is done as follows.

The passage of a typical ray reflecting off the glass/air interfaces of the wedge is found either by using a ray-tracing algorithm, or by considering the optical equivalent of tracing a straight ray through a stack of wedges of length L as is done in FIG. 3. When the ray hits an interface at slightly less than the critical angle θ_{c} it emerges, and the average distance Y from the tip of the tapered slab at which the ray emerges can be related to the angle θ at which the ray was injected by applying trigonometry to FIG. 3:

$$\frac{Y cos {θ}_{c}}{L} = sin θ$$

However, this is only the average distance, for the following reason. When a ray is incident on an image of the glass/air interface at just greater than the critical angle, reflection of the ray is depicted by tracing it through to the next image of the glass/air interface. This represents the side of the wedge which typically has no anti-reflection coating, so the ray is traced on to the next image at which it terminates by emerging from the wedge. While undergoing this double bounce the ray has moved some distance along the wedge, and it is at this section of the wedge where a gap appears in the projected image.

When a ray emerges from the wedge, its angle δθ₂ to the wedge surface is determined by its angle δθ₁ relative to the critical angle before the-ray emerged from the wedge, as shown in FIG. 4. The relationship is:

δθ₂=cos⁻¹(n sin(θ_{c}−δθ₁))

which can be approximated as follows:

$$\begin{matrix}\frac{1}{n} cos ( δ {θ}_{1} ) - \sqrt{1 - \frac{1}{{n}^{2}}} sin ( δ {θ}_{1} ) = \frac{1}{n} cos ( δ {θ}_{2} ) \\ - \sqrt{{n}^{2} - 1 δ} {θ}_{1} \approx - {( δ {θ}_{2} )}^{2} / 2 \\ δ {θ}_{2} \approx \sqrt{2 {δθ}_{1} \sqrt{{n}^{2} - 1}}\end{matrix}$$

If for example the ray is incident at 0.05° less than the critical angle in a glass of refractive index 1.5, then the ray emerges at an angle of 2.53° to the wedge surface. Other angles of incidence will result in other angles of emission as follows:

| n = 1.5 | n = 1 |
|---|---|
| δθ₁ | δθ₂ |
| 0.05 | 2.53 |
| 0.10 | 3.58 |
| 0.15 | 4.39 |
| 0.20 | 5.07 |
| 0.25 | 5.67 |
| 0.30 | 6.21 |
| 0.35 | 6.71 |
| 0.40 | 7.17 |
| 0.45 | 7.61 |

If a space is present between the translucent screen and the wedge-shaped waveguide, the bundle of rays within one horizontal band is projected across the space so as to fill the adjacent gap, as shown in FIG. 5. The height of the gap is equal to twice the thickness t of the tapered transparent slab at that point times the tangent of the critical angle. Furthermore the range of incident angles within the bundle of rays is equal to twice the angle of wedge taper α; rays outside this range will undergo either one bounce fewer or one bounce more. If the greatest incident angle within the ray bundle is θ₀ less than the critical angle, then the thickness s of the space between the tapered transparent slab and the translucent screen should be:

$$s = 2 t t a n {{θ}_{c} ( \frac{1}{tan ( {cos}^{- 1} ( n sin ( {θ}_{c} - {θ}_{0} ) ) )} - \frac{1}{tan ( {cos}^{- 1} ( n sin ( {θ}_{c} - {θ}_{0} - 2 α ) ) )} )}^{- 1}$$

or more approximately:

$$s \approx 2 t \frac{1}{\sqrt{{n}^{2} - 1}} {( \frac{1}{\sqrt{2 {θ}_{0} \sqrt{{n}^{2} - 1}}} - \frac{1}{\sqrt{2 ( {θ}_{0} + α ) \sqrt{{n}^{2} - 1}}} )}^{- 1}$$

A conventional anti-reflection coating is designed to eliminate the reflection of any rays which are likely to be incident on the coating at angles greater than the critical angle. With such a coating θ₀ should be made equal to the angle between a pair of rays illuminating adjacent pixels of the image. At coarse resolutions this is satisfactory, but the projection of rays from the slab to the screen is non-linear, so it is subject to distortion and this is unsatisfactory at fine resolutions.

In a further embodiment of the invention therefore the coating on the tapered transparent slab is designed to reflect all rays incident on the glass/air interface at an internal angle greater than the critical angle minus θ₀ and to transmit all rays incident at an angle less than this, and the transition from reflection to transmission should take place over a change in ray direction of less than the angle between rays illuminating any adjacent pair of rows of pixels. This design can be done using a ray-tracing or coating-design algorithm in the same way as is described in WO 01/72037. For less than 10% distortion, θ₀ should equal α, the angle of taper of the wedge. For other factors of distortion, θ₀ is found as follows.

The angle θ of each ray may be written as the sum of two parts:

θ=θᵢₙₜ+θᵣₑₘ

where θᵣₑₘ is the greatest angle by which θ can be reduced without changing the number of bounces the ray undergoes before being emitted, and θᵢₙₜ is the angle of the ray after this reduction. Assuming that the wedge angle α is an integer divisor of 90°, then:

θᵣₑₘ=rem[(θ+θ_{c}−θ₀),2α]

where the rem function is the remainder after the second operand has been subtracted from the first as many times as possible without resulting in a negative number. Once a ray has emerged from the slab, it travels towards the tip of the wedge before hitting the translucent screen. The distance it travels is s/tan(δθ₂), and since δθ₁=θᵣₑₘ+θ₀ for the ray, this distance is approximately

$$s / \sqrt{2 ( {θ}_{r e m} + {θ}_{0} ) \sqrt{{n}^{2} - 1}} .$$

Now this distance is less than the distance which the ray would have travelled towards the tip had it been on the point of total transmission, which is

$$s / \sqrt{2 {θ}_{0} \sqrt{{n}^{2} - 1}} .$$

So by exceeding the point of total transmission, the ray has undergone a net shift away from the tip of:

$$s {( 2 {θ}_{0} \sqrt{{n}^{2} - 1} )}^{- 1 / 2} - {s ( 2 ( {θ}_{r e m} + {θ}_{0} ) \sqrt{{n}^{2} - 1} )}^{- 1 / 2}$$

Inserting our value for the space s between the slab and translucent screen, we have that the net distance moved away from the tip is:

$$g a p \frac{{θ}_{0}^{- 1 / 2} - {( {θ}_{r e m} + {θ}_{0} )}^{- 1 / 2}}{{θ}_{0}^{- 1 / 2} - {( 2 α + {θ}_{0} )}^{- 1 / 2}}$$

where gap is the height of the gap. This should be added to the distance at which the ray will intersect the slab, giving:

$${Y}_{actual} = \frac{L}{cos {θ}_{c}} sin {θ}_{i n t} + band \frac{{θ}_{r e m}}{2 α} + gap \frac{{θ}_{0}^{- 1 / 2} - {( {θ}_{r e m} + {θ}_{0} )}^{- 1 / 2}}{{θ}_{0}^{- 1 / 2} - {( 2 α + {θ}_{0} )}^{- 1 / 2}}$$

where band is the height of the band. Now there is a band plus gap between adjacent points where rays hit the wedge surface at the critical angle, and the difference in direction between the two rays hitting these points is twice the wedge angle. So the height of the band plus gap combined is:

$$band + gap = \frac{L}{cos {θ}_{c}} [ sin ( {θ}_{i n t} + 2 α ) - sin {θ}_{i n t} ]$$

So we can rewrite the distance at which the ray intersects the slab as:

$${Y}_{actual} = \frac{L}{cos {θ}_{c}} \{ sin {θ}_{i n t} + [ sin ( {θ}_{i n t} + 2 α ) - sin {θ}_{i n t} ] \frac{{θ}_{r e m}}{2 α} \} + gap \{ \frac{{θ}_{0}^{- 1 / 2} - {( {θ}_{r e m} + {θ}_{0} )}^{- 1 / 2}}{{θ}_{0}^{- 1 / 2} - {( 2 α + {θ}_{0} )}^{- 1 / 2}} - \frac{{θ}_{r e m}}{2 α} \}$$

Now θᵣₑₘ is less than 2α, which is small, so cosθᵣₑₘ is approximately 1. So:

$$\begin{matrix}\begin{matrix}{Y}_{actual} \approx \frac{L}{cos {θ}_{c}} \{ sin {θ}_{i n t} cos {θ}_{r e m} + cos {θ}_{i n t} sin 2 α \frac{{θ}_{r e m}}{2 α} \} + \\ gap \{ \frac{{θ}_{0}^{- 1 / 2} - {( {θ}_{r e m} + {θ}_{0} )}^{- 1 / 2}}{{θ}_{0}^{- 1 / 2} - {( 2 α + {θ}_{0} )}^{- 1 / 2}} - \frac{{θ}_{r e m}}{2 α}\end{matrix} \\ and sin 2 α \approx 2 α , so \text{:} \\ {Y}_{actual} \approx \frac{L}{cos {θ}_{c}} sin ( {θ}_{i n t} + {θ}_{r e m} ) + gap \{ \frac{{θ}_{0}^{- 1 / 2} - {( {θ}_{r e m} + {θ}_{0} )}^{- 1 / 2}}{{θ}_{0}^{- 1 / 2} - {( 2 α + {θ}_{0} )}^{- 1 / 2}} - \frac{{θ}_{r e m}}{2 α} \}\end{matrix}$$

The term on the right represents the aberration, and a plot of this shows that it peaks at a maximum. FIG. 6 plots the distance (as a fraction of the height of the adjacent gap) by which rays projected onto the translucent screen are displaced due to distortion, versus the position within the band on the surface of the tapered transparent slab from which the rays are projected. We want the peak to be as small as possible for a distortion-free image, and the position of the peak can be found by setting the differential of the right hand term to zero:

$$\begin{matrix}\begin{matrix}\frac{ⅆ}{ⅆ {θ}_{r e m}} = [ \frac{{θ}_{0}^{- 1 / 2} - {( {θ}_{r e m} + {θ}_{0} )}^{- 1 / 2}}{{θ}_{0}^{- 1 / 2} - {( 2 α + {θ}_{0} )}^{- 1 / 2}} - \frac{{θ}_{r e m}}{2 α} ] \\ = \frac{\frac{1}{2} {( {θ}_{r e m} + {θ}_{0} )}^{- 3 / 2}}{{θ}_{0}^{- 1 / 2} - {( 2 α + {θ}_{0} )}^{- 1 / 2}} - \frac{1}{2 α} = 0\end{matrix} \\ so {( {θ}_{r e m} + {θ}_{0} )}^{- 1 / 2} = \sqrt[3]{\frac{1}{α} [ {θ}_{0}^{- 1 / 2} - {( 2 α + {θ}_{0} )}^{- 1 / 2} ]} \\ and \text{:} {θ}_{r e m} = {{α}^{2 / 3} [ {θ}_{0}^{- 1 / 2} - {( 2 α + {θ}_{0} )}^{- 1 / 2} ]}^{- 2 / 3} - {θ}_{0} .\end{matrix}$$

Inserting this value of θᵣₑₘ into the right hand term in our equation for Y_{actual}, we get that the maximum distance by which a pixel can be shifted is:

$$gap [ \frac{\begin{matrix}{θ}_{0}^{- 1 / 2} - \sqrt[3]{\frac{1}{α}} \sqrt[3]{{θ}_{0}^{- 1 / 2} - {( 2 α + {θ}_{0} )}^{- 1 / 2}} - \\ \frac{1}{2} \sqrt[3]{\frac{1}{α}} \sqrt[3]{{θ}_{0}^{- 1 / 2} - {( 2 α + {θ}_{0} )}^{- 1 / 2}}\end{matrix}}{{θ}_{0}^{- 1 / 2} - {( 2 α + {θ}_{0} )}^{- 1 / 2}} + \frac{{θ}_{0}}{2 α} ] = gap [ \frac{1 - \frac{3}{2} \sqrt[3]{\frac{{θ}_{0}}{α} - \frac{{θ}_{0}}{α} {( \frac{2 α}{{θ}_{0}} + 1 )}^{- 1 / 2}}}{1 - {( \frac{2 α}{{θ}_{0}} + 1 )}^{- 1 / 2}} + \frac{{θ}_{0}}{2 α} ]$$

FIG. 7 plots the maximum distortion (as a fraction of the height of the adjacent gap) versus ratio between the transition angle of the coating and the taper angle of the wedge. It shows that we can reduce aberration by increasing θ₀/α. We can increase θ₀/α by designing the anti-reflection coating so that the transition between reflection and transmission at the glass/air interface takes place at an angle slightly less than the critical angle. If we assume that in the worst instance the gap is as big as the band itself and we want less than 10% peak-to-peak distortion, then the maximum gap fraction should be less than 20%, so θ₀ should equal α.

Suppose, for example, that we want to display 768 rows on a wedge tapering from 1.5 mm to 0.5 mm over a distance of 320 mm. The wedge angle is 0.18°, and the pixel size is 0.42 mm. At the thick end of the wedge the gap is 2.7 mm high, so the height of the band plus gap is 5.4 mm, so there are 13 pixels illuminated by a ray bundle spanning twice 0.18°; giving 0.028° per pixel. It follows that for less than 10% peak-to-peak distortion, the anti-reflection coating should reflect rays up to the critical angle minus 0.18°, then transfer from being reflective to being transmissive over a ray angle change of 0.028°. The angle between the coated wedge surface and the translucent screen should be 0.064°.

It can be difficult to design coatings which reflect light at some angles of incidence on the glass/air interface and not at others. This is particularly so when the light comes from a white source, so a further embodiment of the invention is described which uses coatings that are designed only to eliminate all reflection.

FIG. 8 shows how a prismatic film 5 is inserted between the wedge and the translucent screen. The prismatic film comprises a laminate of two transparent materials, the interface between which follows a saw-tooth contour in a direction parallel to that in which the wedge tapers, but is uniform in the orthogonal direction. The angle at the base and tip of each saw tooth should be 90°, but one side of each saw tooth should be perpendicular to light entering the film through the high-index side at that side's critical angle, which for most cases is approximately 45°. Such a film can for example be made by laminating the acrylic and polycarbonate form of 3M Scotch Optical Lighting film with the prismatic surfaces facing each other, or by coating 3M Scotch Optical Lighting film with a glue of a suitable refractive index.

As rays leave the wedge-shaped waveguide in FIG. 8 their angle relative to the surface of the wedge is only a few degrees, so when they enter the high-index side of the prismatic film, they are refracted back close to the critical angle. It follows that the rays pass through the prismatic interface into the low-index side of the prismatic film with little change in direction, but the critical angle of this film is greater than the high-index side. Therefore when the rays are incident upon the material/air interface, the smallest difference between the incident angle of any ray and the critical angle is the difference in critical angles between the high-index and low-index materials. The difference between critical angles affects linearity in the same way as θ₀ affects linearity in the anti-reflection coating, so for linearity better than 10%, the difference between critical angles should equal the wedge angle, α. Suppose for example that we have an acrylic wedge with a wedge angle of 0.18° and want less than 10% distortion. The prismatic film can be made by coating the acrylic form of 3M's Scotch Optical Lighting Film on the prismatic side with a transparent glue such as that made for example by Norland Optical Adhesives, the glue being chosen to have a refractive index such that its critical angle to air is 0.18° lower than that of acrylic.

The techniques so far described are valid provided that all rays have the same component of direction when this is resolved in the plane of the tapered transparent slab.

WO 01/72037 describes how a video projector, flat projection slab 6 and cylindrical lens or mirror 7 can be used to collimate rays from the video projector into a single in-plane direction so that a magnified image from the video projector appears on the surface of the wedge. But it is difficult to get the focal length of a cylindrical lens shorter than its width unless one uses a Fresnel lens, and Fresnel lenses both scatter light and create image structure in the projected image. The length of the projection slab between projector and lens is therefore greater than the length of the wedge so it is desirable not only to fold the projection slab behind the wedge, but also to fold the projection slab itself in half.

WO 01/72037 further describes how a pair of right-angled prisms may be used to fold the images between two slabs, but the prisms must be made with considerable accuracy. If the sides of the projection slab are parallel then the projected rays may instead be folded by coating the end of the slab with metal and reflecting the projected rays off the end. However, the rays must then pass into the wedge and, with or without a fold, the slight kink between the parallel sides of the projection slab and the tapering sides of the wedge is enough to cause aberrations in the projected image.

These aberrations can be largely eliminated, as shown in FIG. 9, by adiabatically curving one or both surfaces of the projection slab in the region 8 next to one of its ends so that the angle of taper at the end of the projection slab is the same as that of the wedge. The length of this region might be approximately thirty times its thickness in order for the curve to be adiabatic, though it is possible to achieve the desired end in less than that length.

It will now be explained how to calculate the radius of curvature and length of the transition section between flat input slab and tapered wedge. The transition must be gradual, since otherwise either a ghost image or distortion will be introduced, but it should be as short as possible because it forms a margin at the side of the screen.

If we consider rays travelling to the far end of the wedge then gradually reduce their angle of injection, they will at some point undergo one bounce more off the transition curve than before. The extra bounce will introduce extra focus, and the difference from before will be seen as distortion. To analyse this, unfold rays in both slab and wedge so that the only reflection shown is the extra bounce. There may be several other reflections in the transition of course, but it is only the effect of an increment in the number of reflections off the transition which interests us, so we will consider this increment in isolation.

The axis of the focusing mirror formed by the transition is approximately perpendicular to the slab, and the distance from the point of injection to the transition curve along this axis is the slab length, L, divided by the tangent of the angle of injection, θ, as shown in FIG. 9a. The transition forms a virtual image of the point of injection at a distance, V, whose reciprocal equals the reciprocal of L/tan θ minus the reciprocal of twice the transition's radius of curvature:

$$\begin{matrix}\frac{1}{2 r} = \frac{1}{L / tan θ} - \frac{1}{V} \\ so V = \frac{1}{\frac{tan θ}{L} - \frac{1}{2 r}} \approx \frac{L}{tan θ} ( 1 + \frac{L}{2 r tan θ} )\end{matrix}$$

If the size of a pixel is 2 (L/tan θ) δ without the curve, then with the curve the size is:

(V+L/tan θ) δθ

so the distortion is:

$$\frac{L}{4 r tan θ} .$$

The taper angle of a gapless wedge is approximately ½t₀/L, and the length of transition curve needed to reach this taper angle is r times the taper angle, i.e. ½t₀/4d tan θ, where d is the distortion. If the wedge has an initial thickness (i.e. at the thick end) of t₀=10 mm, 74° is the angle of injection to reach the tip of the wedge and a distortion of 1% is allowable, then the length of the transition curve is 36 mm.

Instead of a pair of prisms, as mentioned earlier, the fold between projection slab and wedge may be made either with the cylindrical equivalent of the lens described by J. Dyson in “Unit magnification optical system without Seidel aberrations”, Journal of the Optical Society of America, Volume 49, page 713 (1959) or with a graded-index curve. The cylindrical equivalent of the Dyson lens can be made by placing a 15 mm diameter rod of acrylic in the centre of a cylinder with a 44.45 mm silvered internal diameter, then cutting both in half down their central axis, as shown in FIG. 10. The projection slab and wedge are placed face to face with their ends at this central axis.

The graded-index curve comprises a cylinder which is the same thickness as the projection slab, but whose index increases towards its inner edge in such a way that the optical path length traced at any chosen radius from the centre, from one side of the half cylinder to the other, is the same. A graded-index curve can be made by passing the gaseous components of alternately high-index and low-index glass through a glass cylinder, and altering the ratios between the high and low-index forms in a suitable manner as these are deposited on the inner side of the glass cylinder. The graded-index curve should then be cut in half along its central axis (FIG. 11), the projection or input slab butted to one end of the curve, and the thick end of the wedge butted to the other.

Instead of using a cylindrical lens to collimate rays from the video projector, one can, as shown in FIG. 12, combine the actions of folding and collimation by cutting the unfolded end of the projection slab into a parabola 9, then polishing and silvering this end so that it acts as a cylindrical parabolic mirror. The focus 10 of the parabolic mirror should be off to one side of the projection slab and the video projector placed at this focus. The system can be made yet more compact if light from the video projector 2 is reflected off the side 11 of the projection slab before it goes on to be reflected off the parabola.

For example, if the wedge is 427 mm wide and 350 mm high, the bottom 30 mm being the adiabatic transition from constant thickness to tapering thickness, then the parabolic mirror could have the equation:

y=0.000701x²

where the origin x=0, y=0 is 110 mm beyond the side of the wedge, but folded back to the centre by cutting the edge of the projection slab 55 mm from the side of the wedge, and polishing and silvering it. This collimating system can be used with any flat-panel display, not just that shown in FIG. 5, nor even just a tapered waveguide type.

It is expected that the manufacture of folding prisms will in due course be sufficiently precise to fold the projection slab to the wedge compactly, in which case it is desirable to eliminate all bulk by making the video projector itself flat. This can be done, as shown in FIG. 13, by removing the display element 15 from the video projector, be it a liquid-crystal display or otherwise, and placing the face of the display element against a small tapered transparent slab 12. A point source of light is injected into the thick end of the wedge and is collimated by a parabolic mirror, lens or holographic lens, for example. A holographic optical element 13 is inserted between the liquid-crystal display and wedge, with a wedge-shaped space 14 between the holographic optical element and wedge with dimensions chosen so that the holographic optical element is illuminated without gaps.

The spatial frequencies of the holographic optical element are arranged so that all rays are bent almost perpendicularly towards the face of the liquid-crystal display, which operates in reflection, so that the reflected rays are returned almost along their original path. The orientation of the display element 15 is adjusted so that the returned rays condense to a point adjacent to that at which they were injected, and a projection lens is inserted at the waist of the returning ray bundle. Then the rays are passed into the projection slab (not shown). The projection lens is preferably itself slim, and can for example be made by sandwiching lens-shaped sections of float glass between a pair of front-silvered mirrors. The transition from the injection wedge to the projection slab must be made adiabatic by gradually varying the angle of taper in the same way as for the display of the image. However, this projector system could be used with any display, not just the wedge type described in WO 01/72037.

In FIG. 13 three bands are shown, and a wedge-shaped gap is formed between the tapered waveguide and the generally flat surface of the LCD modulator with its glass plate and hologram. However, if only one band of the emerging light is used there is no need for the dark-strip-eliminating system to be used and the gap 14 need not be tapered.

The source of illumination should also preferably be compact, and while laser diodes are sufficiently small, they have yet to reach the powers needed for video projection. The arc lights which are used instead are not small, and they also have the disadvantage of failing after one or two thousand hours and being difficult to replace. Preferably therefore the arc light should be housed separately, either in the computer driving the display or in a housing around the wall plug. Light from the arc should be condensed into an optical fibre, and this should be terminated at the point where light is to be injected into the display system.

An important advantage of projection is that the liquid-crystal display is small and it is easier to perform high-resolution lithography over small areas. If the transistor array underneath the liquid-crystal display is made out of a high-mobility semiconductor such as crystalline silicon then sophisticated algorithms such as decompression may be done within the liquid-crystal display, and only a few, low-data-rate connectors are needed to drive the video image.

Some video projectors create colour images with the use of three liquid-crystal displays—one each for red, green and blue—and a pair of dichroic mirrors to combine the colour images. The same system may be used here by inserting dichroic mirrors into the projection slab and providing a liquid-crystal display and wedge at,the focal point of the parabola for each colour. The two dichroic mirrors may be inserted by cutting the slab along one line for each mirror, depositing the mirror along one or other edge formed by the,cut, then joining the projection slab back together again.

A compact screen can be made without folding by placing two wedges 1a, 1b tip to base, and condensing the light from two video projectors 2a, 2b into the thick ends of the wedges see FIG. 14. The facing surfaces of the two wedges are each covered in an anti-reflection coating, and a single translucent screen is inserted between them. Each wedge is spaced away from the anti-reflection coating so that the gaps between the image bands are eliminated. The left-hand half of the image is sent to the right-hand video projector, and the right-hand half of the image is sent to the left-hand video projector. Each half-image must be predistorted so as to correct keystone aberrations, and the two image halves should overlap at the centre, the transition from one half to the other being made gradual so as to eliminate any noticeable video transition. Of course, this system does use two projectors, which may be undesirable.

1. A flat-panel projection apparatus comprising a tapered transparent slab waveguide (1), a projector (2) adapted to inject images into the thick end of the slab so that rays from each point of the image are totally internally reflected and eventually emerge from one of the faces of the slab at a location dependent on its angle of injection into the end of the slab, a translucent screen (3) over the face of the slab from which the display is to be viewed, and a spacing means holding the screen away from the slab in such a way that light emerging from the face of the slab, in bands with gaps between them as a result of a difference in the number of internal reflections of rays from the same image point, can spread to close the gaps on the screen.

2. A flat-panel projection apparatus according to claim 1, in which the faces of the slab waveguide and screen are planar and the angle σ between the screen and the adjacent surface of the tapered waveguide approximately satisfies:
$$σ = α \frac{2 \sqrt{2} {( {n}^{2} - 1 )}^{- 1 / 4}}{\frac{1}{\sqrt{{θ}_{0}}} - \frac{1}{\sqrt{{θ}_{0} + 2 α}}}$$
where n is the refractive index of the tapered slab waveguide, α is the angle of taper of the slab, and θ₀ is the angle by which a ray's incident angle must be less than the critical angle if it is to be substantially transmitted by the glass/air interface next to the translucent screen.

3. A flat-panel projection apparatus according to claim 1, in which the gap height s between waveguide and screen approximately satisfies:
$$s \approx 2 t \frac{1}{\sqrt{{n}^{2} - 1}} {( \frac{1}{\sqrt{2 {θ}_{0} \sqrt{{n}^{2} - 1}}} - \frac{1}{\sqrt{2 ( {θ}_{0} + α ) \sqrt{{n}^{2} - 1}}} )}^{- 1}$$
where t is the thickness of the tapered waveguide at the point in question and the other quantities are as defined in claim 2.

4. A flat-panel projection apparatus according to any preceding claim, in which the slab is made of a material of refractive index of about 1.5 and has a taper angle of about 0.18°.

5. A flat-panel projection apparatus according to any preceding claim, in which the emitting surface of the wedge (1) has a prismatic sheet (5) for magnifying the angle of escape from the slab.

6. A flat-panel projection apparatus according to any preceding claim, in which the apparatus is a display.

7. A flat-panel projection apparatus according to any preceding claim and including a flat input slab waveguide (6) into one end of which the light is input so as to be expanded over the width of this slab, the light emerging into the tapered waveguide slab from the input slab.

8. A flat-panel projection apparatus, in particular according to claim 7, in which the transition from the input waveguide (6) to the tapered waveguide (1) is gradual.

9. A flat-panel projection apparatus according to claim 7 or 8, in which the input waveguide has a collimating reflecting surface.

10. A projector comprising a light source, a tapered slab waveguide (12) into the thick end of which the light is injected so as to emerge over the face of the waveguide, and a display element (15) modulating this light and reflecting it back through the waveguide.

11. A projector according to claim 10, in which a holographic element (13) is used to divert the light between the slab and the display element so that it travels to and from the latter substantially perpendicularly.

12. A projector according to claim 10 or 11, in which the tapered slab waveguide (12) is arranged at an angle (14) to the face of the modulator (15), so that light emerging from the face of the slab can spread to cover the area of the modulator.
